(19) United States
(12) Patent Application Publication
(10) Pub. No.: US 2016/0303795 A1
(43) Pub. Date: Oct. 20, 2016

(54) All Dimension Fabrication Apparatus and Methods

(71) Applicant: Lehigh University, Bethlehem, PA (US)

(72) Inventors: Yaling Liu, Ambler, PA (US); Ran He, Bethlehem, PA (US); Wentao Shi, Bethlehem, PA (US)

(21) Appl. No.: 15/098,956

(22) Filed: Apr. 14, 2016

Related U.S. Application Data
(60) Provisional application No. 62/290,442, filed on Feb. 2, 2016.
(60) Provisional application No. 62/147,821, filed on Apr. 15, 2015.

(51) Int. Cl. B29C 67/00

(52) U.S. Cl. CPC B29C 67/0055; B29C 67/0085; B33Y 10/00

(57) ABSTRACT

A fabrication apparatus and method for continuous printing all dimensions of a 3D object that includes a platform and a gas-permeable flexible film that has a carrier surface, wherein a printing area is defined between the platform and the film. A reservoir holding a photocurable resin is in the printing area. A pressure controlled air chamber is adjacent the reservoir and sealed by the film, the film dividing the reservoir and the pressure controlled air chamber. A light exposing device is configured to cure the printing area through the gas-permeable film to form the object from the photocurable resin. A fabrication apparatus and method for printing a 3D object that includes a linear actuator for moving the exposure device that operates with a control device to provide moving exposure images into a resin area larger than the size of a single image.

### CROSS-REFERENCE TO RELATED APPLICATIONS

This application claims priority to U.S. Provisional Application Ser. Nos. 62/147,821 and 62/290,442, filed on Apr. 15, 2015 and Feb. 2, 2016, respectively, the entireties of which are hereby incorporated herein by reference.

### BACKGROUND

Conventional manufacturing or 3D printing techniques involve forming the object by building layers on top of layers. Such techniques are slow and often form voids in the object, thereby reducing the mechanical yield strength of the object. Additionally, any increase in resolution of the object significantly increases print time. Other 3D printing techniques include bottom-up printing, such as disclosed in U.S. Published Application No. 2016/0059487 to De-Simone et al., the subject matter of which is herein incorporation by reference. However, such bottom-up techniques are expensive and often incorporate additional mechanical steps increasing printing time.

Therefore, a need exists for an apparatus and method for all dimensional fabrication of an object that provides faster printing speeds for complex and larger shaped objects with high resolution at lower cost.

### SUMMARY

Accordingly, an exemplary embodiment of the present invention provides a fabrication apparatus for continuous printing an all dimensional object that includes a platform and a gas-permeable flexible film that has a carrier surface, wherein a printing area is defined between the platform and the gas-permeable flexible film for printing the object. The gas-permeable film is optically transparent. A reservoir holding a photocurable resin is in the printing area. A pressure controlled air chamber is adjacent the reservoir and sealed by the gas-permeable flexible film such that the gas-permeable flexible film divides the reservoir and the pressure controlled air chamber. At least a portion of the pressure controlled air chamber is optically transparent. A light exposing device is configured to cure the printing area through the gas-permeable flexible film to form the object from the photocurable resin. In a preferred embodiment, the printing area includes an isolating layer on the carrier surface of the film where the isolating layer inhibits polymerization of the resin, thereby allowing the object to separate from the film.

The present invention may also provide a method for continuous fabrication of an all dimensional object that includes the steps of, providing a printing area defined between a platform and a gas-permeable flexible film, the gas-permeable film being optically transparent; providing a reservoir holding a photocurable resin in the printing area; providing a pressure controlled air chamber adjacent the reservoir and sealed by the gas-permeable flexible film such that the gas-permeable flexible film divides the reservoir and the pressure controlled air chamber, at least a portion of the air chamber being optically transparent; and curing the photocurable resin in the printing area through the gas-permeable flexible film to form the object while lifting the object away from the gas-permeable film. In a preferred embodiment, the method may include the step of supplying a predetermined concentration of oxygen to the pressure controlled air chamber and through the gas-permeable film to inhibit polymerization of the resin, thereby creating an isolating layer on the gas-permeable film.

The present invention may yet further provide a method for fabrication of an all dimensional object that includes the steps of providing a platform for building the all dimensional object, the platform is movable in a Z direction; providing a reservoir holding a photocurable resin in the printing area; providing an exposure device for curing the photocurable resin in the printing area; providing a linear actuator coupled to the exposure device for linearly sliding the exposure device in an XY plane while curing the photocurable resin; providing a control device operatively coupled to the exposure device and the linear actuator to provide exposure images for printing the object; and printing the all dimensional object by sliding the exposure device using the linear actuator and projecting the exposure images into the photocurable resin.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view of an all dimensional fabrication apparatus in accordance with a first exemplary embodiment of the present invention;

FIG. 2 is a flow diagram of an exemplary printing process of the fabrication apparatus illustrated in FIG. 1;

FIG. 3 is another schematic view of the fabrication apparatus illustrated in FIG. 1, showing an oxygen supplier and a pressure control in accordance with an exemplary embodiment of the present invention;

FIG. 4 is a schematic view showing an application of an oxygen concentration system of the fabrication apparatus illustrated in FIG. 3;

FIGS. 5A and 5B are schematic views showing an application of a pressure control system of the fabrication apparatus illustrated in FIG. 3;

FIGS. 6A and 6B are exploded and perspective views of a tightening mechanism of the fabrication apparatus in accordance with an exemplary embodiment of the present invention;

FIGS. 7A and 7B are perspective views of alternative reservoir sliding systems of the fabrication apparatus in accordance with an exemplary embodiment of the present invention;

FIG. 8 is a perspective view of a linear actuator of a fabrication apparatus and method in accordance with a second exemplary embodiment of the present invention;

FIG. 9 is a schematic view of a slicing process of a slicer algorithm in accordance with the second exemplary embodiment of the present invention;

FIG. 10 is a schematic view of a printing process in accordance with the second exemplary embodiment of the present invention, showing the sliding pathway of the exposure device of the fabrication apparatus and the change of exposure images for a target exposure image;

FIG. 11 is a schematic view of a bottom-up printing system that may be used with the fabrication method of the second exemplary embodiment;

FIG. 12 is a flow chart of the printing process of the system illustrated in FIG. 11;

FIG. 13 is a schematic view of a top-down printing system that may be used with the fabrication method of the second exemplary embodiment; and

FIG. 14 is a flow chart of the printing process of the system illustrated in FIG. 13,

### DETAILED DESCRIPTION OF THE EXEMPLARY EMBODIMENTS

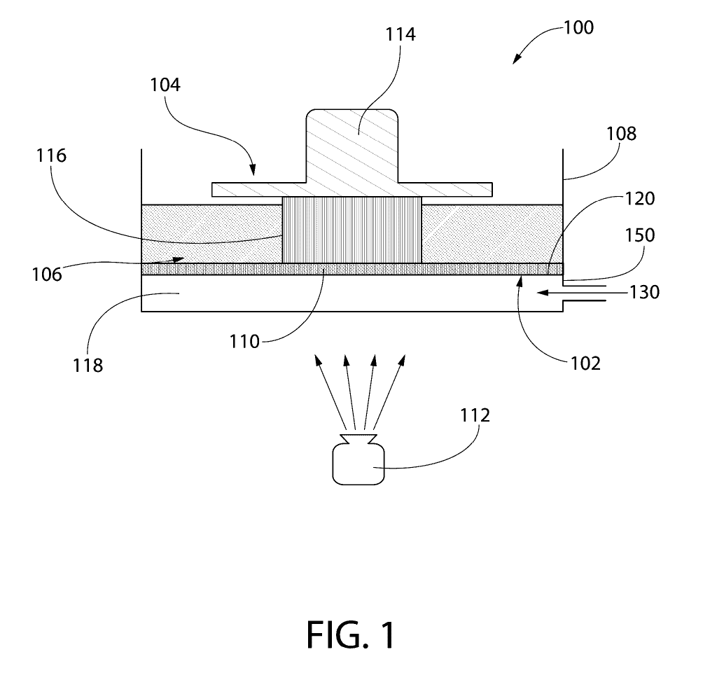

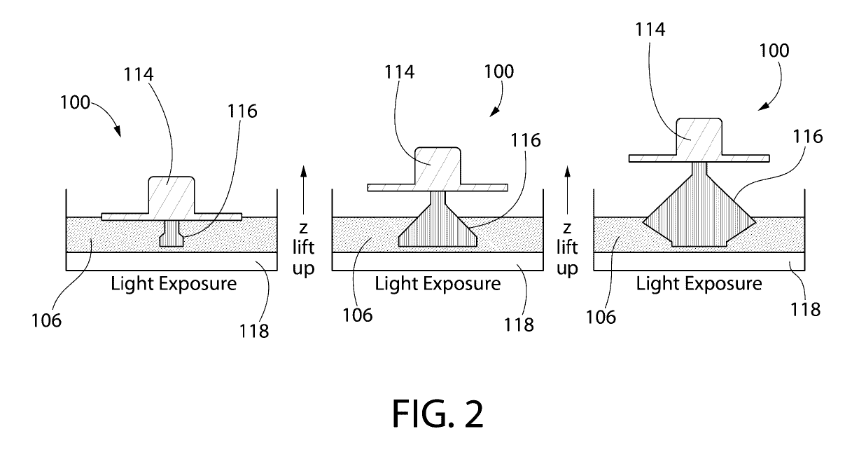

Referring the FIGS. 1-4, 5A, 5B, 6A, 6B, 7A, and 7B, a first exemplary embodiment the present invention generally relates to an all dimensional fabrication apparatus 100 and method that enables continuous printing at high speed and high resolution 3D object manufacturing. The first embodiment of the present invention utilizes a gas-permeable flexible film 102 on which to build the object and an associated mechanical assembly 104 to achieve the high speed and high resolution 3D continuous printing of the object. The film 102 is preferably maintained under tension and is used to retain a photocurable resin 106 in a reservoir 108. The film 102 is preferably optically transparent while allowing the permeation of gas, such as oxygen, to inhibit the resin's photocuring process or polymerization to continuously form an isolating or inhibited layer 110. Light from a source, such as an exposure device 112, is passed through the film 102, enabling the curing of an entire layer of the object according to a predetermined shape or design. As the resin is cured, the object is lifted away from the film 102 by a platform 114 of the mechanical assembly 104, thereby enabling another layer of the object to be formed in the printing area 116 between the platform 114 and the film 102, as shown in FIG. 2. The isolating layer 110 allows the object to easily separate from the film 102, thereby eliminating the need for additional mechanical steps to create that separation, which could complicate the apparatus, slow the method, and/or potentially distort the printed object. The present invention preferably includes an air chamber 118 that is sealed by the film 102, to facilitate supply of an inhibiting gas, such as oxygen, which maintains the isolating layer 110, and to help maintain the flexible film 102 in a substantially flat state using pressure control. At least portion of the chamber 118, such as the bottom, is optically transparent to allow light through the chamber 118 to the film 102 and the resin 106 in the reservoir 108.

The fabrication apparatus 100 and method of the present invention, which provides continuous printing, is less expensive than traditional 3D printing techniques and produces higher resolution objects at faster speeds. For example, an object may be printed up to about 9 mm/minute using the present invention. Thus, for example, it takes only 12 minutes to print an object as tall as 100 mm The preferred resolution produced by the present invention may be, for example, (1) X and Y resolution: 40-80 mm; Z resolution: up to 1 μm slicing resolution; and build volume: 150 mm×86 mm×250 mm; or (2) X and Y resolution: up to 20 mm; Z resolution: up to 1 μm slicing resolution; and build volume: 300 mm×300 mm×300 mm. The build volume of the printed object can be further extended using the present invention. Also, complex objects, which are not limited by porous structures, and objects with solid inner structure, may be printed using the present invention.

Other advantages of the fabrication apparatus 100 are that, unlike the conventional 3D printing techniques, the continuous fabrication apparatus 100 of the present invention is capable of printing large enough structures with solid interiors and capable of printing the solid interior as fast as printing small and porous structures; capable of maintaining the film 102 in a substantially flat state; capable of preventing the deformation of the film 102 when printing large areas; capable of preventing the overheating of the film 102 that may be generated by the polymerization process; capable of providing a constant supply of inhibitor, such as oxygen, to maintain the isolated layer 110; and capable of tuning the thickness of the isolating layer 110.

The film 102 is preferably thin (for example less than 100 micrometers) and flexible (that is, not rigid), for both supporting the resin 106 and allowing gas transmission. Film 102 is optically transparent and may be non-sticky with respect to the photocurable resin 106. Film 102 enables oxygen to permeate therethrough, where the oxygen can act as an inhibitor of the photocuring or polymerization process of the resin 106. With the inhibition of oxygen, the isolating layer 110 is formed between the object being printed and a carrier surface 120 of the film 102. The isolating layer 110 stays in an uncured form enabling easy separation of the object from the film 102, even during an inadvertently long time of exposure from light exposure device 112. The thickness of the isolating layer 110 preferably range from about 20 μm to 1000 μm and a preferred polymerization gradient thickness ranges from about 10 μm to 500 μm.

Because the film 102 is thin, it is less expensive while also allowing for a higher oxygen permeability. Film 102 may be permeable such that it preferably has an oxygen permeability larger than 7.5*10⁻¹⁹ m²s⁻¹Pa⁻¹ (0.1 Barrer). Film 102 may be formed, for example, of a semipermeable silicone rubber, a gas permeable polymer, a combination thereof, and the like. Such materials also make the film 102 less expensive.

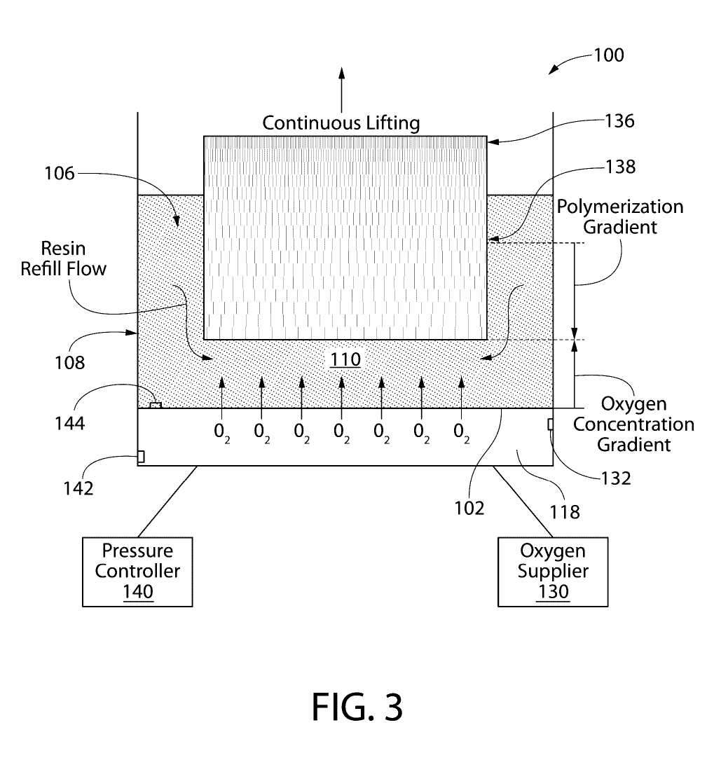

An oxygen concentration control system 130 may be provided that is operatively coupled to air chamber 118, as seen in FIG. 3. The oxygen concentration control system 130 may include, for example, one or more oxygen suppliers (e.g. oxygen concentrator, oxygen generator, oxygen tank, and the like) with one or more oxygen sensors 132 and valves for detecting and adjusting the oxygen concentration in air chamber 118. The air chamber 118 may include air inlets and outlets connected to the oxygen concentrators and generators of the oxygen concentration control system 130. The outlet of an oxygen source may be connected to the inlet of the pumping devices that inject the oxygen into the air chamber 118. The concentration of oxygen can be controlled by a mixer which mixes oxygen and air to form different concentrations of oxygen. The concentration of oxygen can range from 20% to 100% of the total volume of the air chamber 118.

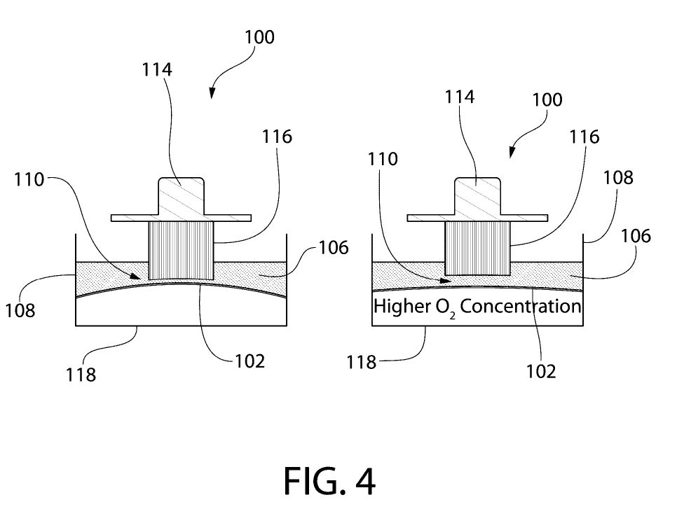

The oxygen concentration control system 130 supplies a predetermined concentration of oxygen to the air chamber 118 and to the reservoir 108 through the film 102 based on the desired thickness of the isolating layer 110. The desired thickness of the isolating layer 110 may be selected for facilitating separation of the object from the film 102 and/or assisting with maintaining the film in a substantially flat (non-deformed) state, as seen in FIG. 4. The thickness of the isolating layer 110 can counteract any deformation in the film 102 caused by a vacuum created between the carrier surface 120 of the film 102 and the object being printed. Thus the oxygen concentration in the air chamber 118 may be tuned using the oxygen concentration control system 130.

The photocurable resin 106 of the present invention may be composed of oligomers, monomers, initiators and additives, such as pigments, dyes, and the like. Initiators can generate radicals after initiation by certain wavelength of light. The radicals can either activate functional groups in oligomers and monomers to lead to polymerization or be inhibited by inhibitors. Oxygen acts as one of the inhibitors, and it can permeate through the film 102 by passive transportation. Oxygen deactivates radicals so that the resin stays liquid form because of no polymerization. A small amount of oxygen can be transported due to the low permeability of the film 102 but enough to create a thin layer (e.g. from about 20 μm to 1000 μm) of uncured resin, that is isolating layer 110, which helps separation of the object and the film's carrier surface 120. That is, it is preferred that the amount of oxygen that penetrates through the film 102 is the same amount that is consumed by the polymerization process.

The resin 106, which is polymerized by exposure device 112, may be replenished from the surrounding area. The refilled resin may have a lower oxygen concentration, such that the concentration difference from two sides of the film 102 induces oxygen diffusion from the other side of the film 102, and forms a decreasing oxygen concentration gradient above film 102. As the height increases (height meaning the distance to the film 102), the concentration of oxygen is lowered, and on the plane where the oxygen concentration is lower than a threshold that the oxygen cannot suppress all the radicals, polymerization happens. That is the longer the distance to the film is, the lower the concentration of oxygen will be. Above the threshold plane, although the polymerization process happens, there are not enough radicals to fully cure the resin, thus a polymerization ratio gradient is formed. As the height increases, the polymerization ratio increases, and is eventually close to the maximum ratio, which is expressed by a fully cured region 136 in the printing area 116. In the polymerization gradient part, partially cured resin in a partially cured region 138 of the printing area 116, has potential to form stronger bonding with the following polymerized resin once it is fully cured later on, because there are more unreacted functional groups participate the later on polymerization in partially cured resin comparing with well cured resin.

The platform 114 preferably has a constant lifting speed. With that constant platform lifting speed and constant oxygen supply from the oxygen concentration control system 130, the two gradients can balance each other to form a constant inhibited or isolating layer 110, which shows as the oxygen concentration gradient. Under similar conditions (such as same lifting speed, same diffusivity, etc.), a higher initial oxygen concentration leads to larger distance that it needs to reduce the oxygen concentration to the threshold. Therefore, increasing the concentration of oxygen in the supplier can accelerate the oxygen diffusion and increase the thickness of the isolation layer 110. As increasing pressure of oxygen also promotes its permeability, it has the same effect on tuning the thickness of isolating 110.

The oxygen concentration control system 130 may also diffuse heat generated by the curing process. Polymerization of the resin 106 creates heat which can impact the mechanical properties of the 102, including increasing the permeability of the film 102. An increased permeability of the film may allow penetration of gasified resin. A majority of the gasified resin may come across the film, while a minority of it may stay inside the film, making the film cloudy and blocking the transmission of the light from the exposure device 112 to cure the resin 106. The cloudy film could affect the printing quality of the objects. A thicker isolation layer increases the distance between the polymerization plane and the film 102, and thus the heat generated by polymerization is less likely to transfer to the film 102, and more likely to transfer to the surrounding area. The preferred thickness of the isolation layer 110 that can isolated the heat may be about 100 μm to 500 μm. The thicker the isolation layer 110 the better isolation of the heat. The thickness may be vary, however, for different materials. For different materials, the heat can be different and thus the thickness of the isolation layer may be related to the material properties and thus vary from the above preferred thickness. The control of the oxygen concentration via the oxygen concentration control system 130 can adjust the thickness of the isolation layer 110 as well as the polymerization gradient layer to properly help the diffusion of the heat generated by polymerization. Thus creating a thicker isolation layer 110 can cool down the temperature of the resin 106 between the isolating layer 110 and the film 102, thereby avoiding overheating of the film.

The oxygen concentration control system 130 can also reduce the vacuum force generated between the object being printed and the film 102. One factor that affects the magnitude of the vacuum force is the thickness of the isolating layer 110. Because the isolating layer thickness can be controlled by the oxygen concentration control system 130, the vacuum force can be reduced by the proper increase of the oxygen concentration in the air chamber 118. For some resin with higher viscosity, a thicker isolating layer facilitates the separation between the printed object and the gas-permeable film.

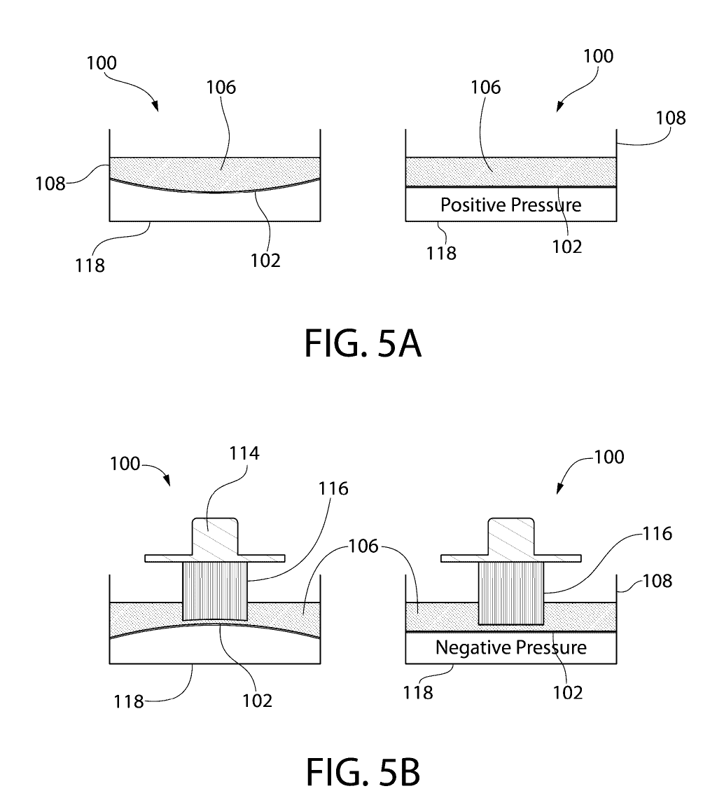

A pressure control system 140 may be provided that is operatively coupled to the air chamber 118, as seen in FIG. 3. The pressure control system 140 may increase or decrease the pressure in the air chamber 118 to maintain the film 102 in a substantially flat non-deformed state, as illustrated in FIGS. 5A and 5B. The pressure control system 140 can generate and adjust both positive and negative pressures in the air chamber 118 below the film 102. The pressure in the air chamber 118 can be increased by applying pumps, pistons, or other air injecting devices to the chamber and can be decreased by applying vacuum pumps, pistons, or other sucking devices to the chamber. The air chamber 118 may include air inlets and outlets connected to air pumps and/or vacuum pumps of the pressure control system 140.

The positive or increased pressure in the air chamber 118 may be used to balance the pressure created by the resin's gravity, thereby keeping the film 102 in a substantially flat state, as seen in FIG. SA. The negative pressure in the air chamber 118 may be applied whenever the vacuum force between the object being printed and the film 102 is large enough to deform the film 102. That vacuum force is typically generated between the printing object and the film 102 when the platform 114 is lifting the object away from the film 102. The magnitude of the vacuum force depends on the printing size, the thickness of the isolating layer 110 and the resin's viscosity. The negative pressure will balance the pressure generated by the vacuum force to keep the film 102 substantially flat and not deformed, as seen in FIG. 5B.

One or more pressure sensors 142 may be applied in the air chamber 118 and resin reservoir 108, for detecting the pressure on both sides of the film 102. A tension sensor 144 may be applied on the film 102 to detect the deformation of the film 102 and prevent the possible breakage of the film 102. Feedback signals of these sensors 142 and 144 may be coupled to a control to synchronize with the pressure and oxygen concentration controlling systems 140 and 130. Thus, the pressure can also be dynamically changed/controlled according to the area of the projected image which corresponds to the level of vacuum force. And by adjusting the oxygen concentration along with the pressure in the air chamber 118, the film 102 can be kept flat during the printing process.

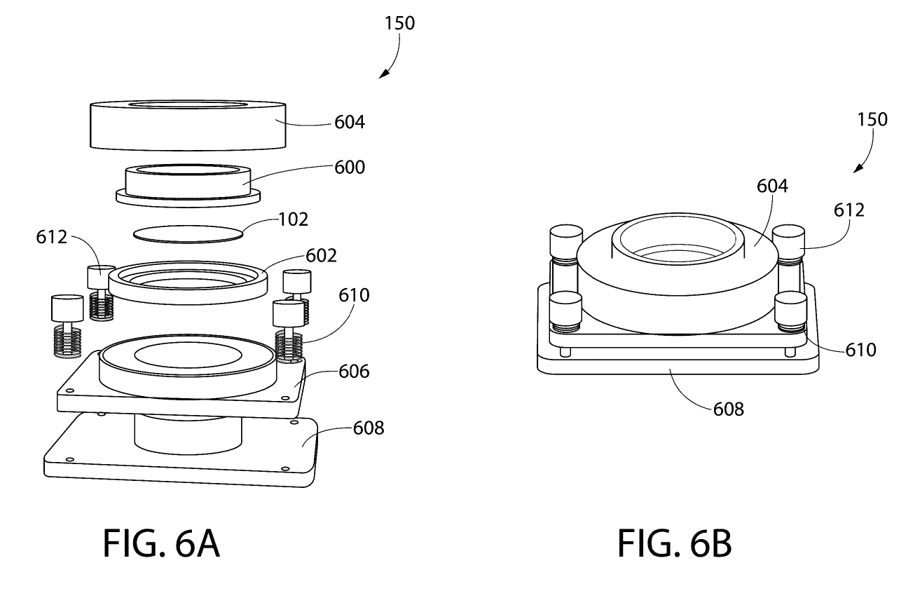

Because of the flexible nature of the film 102, a film tightening mechanism 150 may be optionally provided to stretch the film 102, thereby creating tension in the film 102 and keeping the film 102 substantially flat without ripples. The tightening mechanism 150 is preferably incorporated into the reservoir 108. For example, the tightening mechanism 150 may include a round shaped reservoir equipped with an equiaxial stretching mechanism, as seen in FIGS. 6A and 6B. Film 102 may be put inside a film holder that includes two parts 600 and 602 with an elastic gasket in between. The film holder 600 and 602 may be compressed by a cover cap 604 that has an internal thread and a base 606 of reservoir that has a corresponding external thread. The cover cap 604 and the base 606 can be screwed tightly to eliminate any gap between the film and the film holder. A supporting pedestal with an extruded hollow cylinder 608 may be connected to the bottom of the reservoir 108. By adjusting the distance between the supporting pedestal 608 and the bottom of the reservoir 108, the film 102 may be stretched under the force of the extruded cylinder and to form a flat state, that is a substantially flat surface without ripples. The film 102 can be easily replaced by simply unscrewing the cover cap 604. Alternatively, the tensioning mechanism 150 may include a reservoir that has a substantially parallelogram shape with a uniaxial or biaxial stretching mechanism. In this case, the film holders, cover, base, pedestal with the extruded support all have substantially parallelogram shapes. Parallelogram shapes (especially the rectangular shape) can match the exposure device's exposure area as well allowing the volume of the reservoir to be fully used. In both of these cases, a tension sensor can be installed inside the holder or on the film in order to detect the tension of the film 102. If the film is loose, the distance between the base and the pedestal will decrease to stretch the film until certain tension is applied again. Another approach to adjusting the film tension is providing compression springs 610 (FIG. 6A) between a screw 612 and the reservoir base 606. The springs 610 help to keep the film constantly tensioned. Applying tension to the film 102 is not limited to the alternatives above. Other tensioning and stretching methods (such as vacuum based mechanism) or other film clamping method may be used to maintain the flatness of the film.

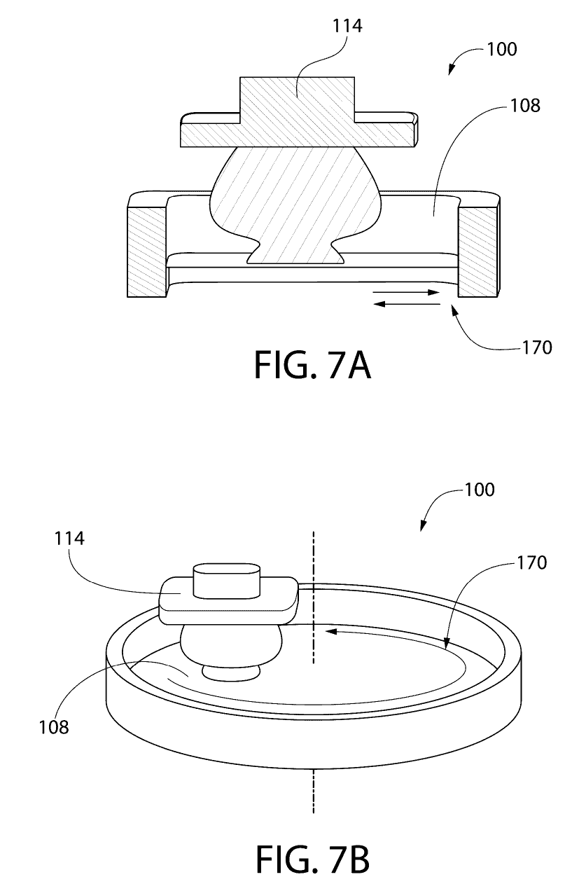

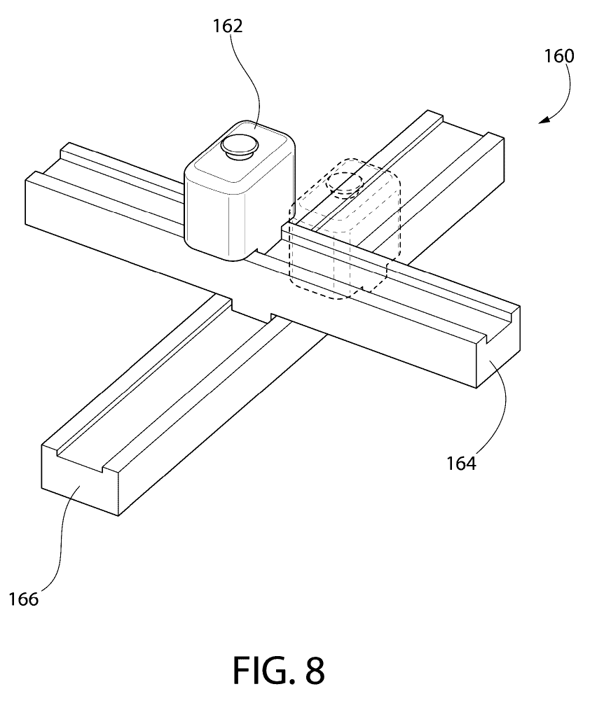

The present invention may also optionally include a reservoir sliding system (FIGS. 7A and 7B) to refresh the photocurable resin 106 and dissipate heat often caused by high speed polymerization of the resin. The reservoir sliding system may include a sliding mechanism 170 that creates relative motion uninterruptedly between the reservoir 108 and the printed object. When printing a large flat surface, for example, a vacuum may occur at the bottom of the surface because the isolating layer 110 below the printing object may not have enough time to be refreshed. As a result, printing resolution may be affected by the possible deformation of the film 102. The sliding of reservoir 108 via the sliding mechanism brings fresh resin into the bottom layer and helps in eliminating any vacuum. Because the resin curing process often generates heat that can slightly deform the film 102, the sliding of reservoir 108 may also help to dissipate the heat in the isolation layer 110. The sliding mechanism 170 could be achieved by moving the reservoir in the horizontal direction back and forth with respect to the platform 114, as seen in FIG. 7A, or by rotating the reservoir around in the vertical direction with respect to the platform 114, as seen in FIG. 7B. The rotating type of sliding mechanism would preferably include a round shaped reservoir, which can create a constant resin flow to refresh the isolating layer 110. In a preferred embodiment, the sliding of reservoir 108 and the lifting of platform 114 happen at substantially the same time.

The present invention preferably includes a control device, such as a programmable computer, that may be programmed to select the desired shape or design of the object to be printed and communicates the same to the exposure device 112. The control device may also be programmed to precisely and dynamically control the pressure in the air chamber 118 via the pressure control system 140 as well as programmed to precisely and dynamically control the supply of oxygen via the oxygen concentration control system 130. The control device may include algorithms for synchronizing the pressure control system 140, the oxygen concentration control system 130, the tensioning mechanism 150, and refilling of the reservoir 108. The control device preferably analyzes the shape and size of each slicing layer of the object being printed, calculates the vacuum force between the object and the film 102, and adjusts the oxygen concentration and pressure levels to provide the isolating layer 110 with the appropriate thickness to obviate any vacuum. The control device may receive feedback from the pressure, oxygen, and tension sensors located in the apparatus 100.

The method for continuous fabrication of an all dimensional object in accordance with the first exemplary embodiment of the present invention includes the light exposure device 112 projecting exposure images/patterns toward the photocurable resin 106 to form a polymerized layer of the object to be printed. The exposure device 112 may be any known projecting device for irradiating resin or liquid, such as via UV or visible light. Anywhere the resin 106 that has been exposed under light of the exposure device 112 is cured and becomes part of the printed object.

The layer of the object being printed may be isolated from the film 102 by the isolation layer 110. The thickness of the isolation layer 110 is controlled by the oxygen concentration in the air chamber 118 supplied by the oxygen concentration control system 130. At this stage of the printing process, positive pressure may be applied in the air chamber 118, via pressure control system 140, to keep the film 102 substantially flat when the platform 114 is close to the film 102. The pressure in the chamber 118 may be dynamically decreased when the distance between the platform 114 and the carrier surface 120 of film 102 is increased.

The exposure device 112 may continuously irradiate toward the photocurable resin 106 to form the polymerization gradient. The platform 114 carrying the polymerized object moves away from the film 102. The platform 114 preferably moves continuously away from the film at a high speed, such as 500 μm/s. The isolation layer 110 is continuously formed to isolate the polymerized object from the film 102. The pressure in the air chamber 118 may be dynamically changed via the pressure control system 140 to maintain the flatness of the film 102. The oxygen concentration may be dynamically changed to maintain the isolation layer 110.

The exposure device 112 may alternatively sequentially project images/patterns toward the resin 106. During the transition of two exposure images, the polymerization pauses because no irradiation will be projected to the photocurable resin 106. The platform 114 carrying the polymerized object moves up during each transition of two exposure images. Again, the isolation layer 110 may be continuously formed to isolate the polymerized object from the film 102.

The pressure in the air chamber 118 may be reduced by a sucking device, such as a vacuum pump, to eliminate the suction between the object being printed and the film 102. Then the pressure in the chamber 118 may be increased by a pumping device to make the film 102 substantially flat again. And the oxygen concentration may be dynamically changed to maintain the isolation layer 110.

Referring to FIGS. 8-14, a second exemplary embodiment of the present invention provides an all dimensional fabrication apparatus and method that incorporates a linear actuator 160 for moving the exposure device 112 in an XY plane where both the actuator 160 and exposure device 112 are operatively associated with a programmable control device for providing exposure images to build a high resolution and large 3D object.

The linear actuator 160 is coupled to the exposure device 112 for linearly moving the exposure device 112 while printing. The linear actuator 160 may include a support mount 162 that couples to the exposure device 112 and slides along arms 164 and 166 of the actuator 160, as seen in FIG. 8. The arms 164 and 166 are preferably perpendicular to each other to allow the exposure device 112 to travel linearly in both the X and Y directions. One of the arms 164 may also slide with respect to the other arm 166.

Using the linear actuator 160, the exposure device 112 can move continuously in the X and Y directions while exposing images and patterns into the resin during the 3D printing process. The building volume of the printed object is determined by the entire area in the scanning range of the exposure device 112 rather than a single exposure area of the exposure device. Thus, with the help of the linear actuator 160, the fabrication apparatus of the second exemplary embodiment is capable of printing a very large printing volume (e.g. 1200 mm×1200 mm×1200 mm currently) as well as having a high printing resolution (e.g. up to 1 μm). The exposure device shifting speed via the linear actuator can be as fast as 1000 mm/s, for example. The printing volume can be further extended by simply enlarging the travel distance of projecting device in X, Y and Z directions. The exposure devices can be placed on and moved by any platform that can achieve controlled motion, including but not limited to linear stages, belt transmission systems or robotic arms.

The programmable control device preferably includes a slicer algorithm for producing the exposure images for printing the object. The slicer algorithm slices a 3D model that is representative of the object to be printed, into continuous image patterns 180 for exposure into the resin via the exposure device 112. The exposure device 112 with the linear actuator 160 may continuously project the exposure images during the XY sliding process without pause. With the slicer algorithm of the present invention, the exposure image pattern changes every time the exposure device 112 moves a step distance, which is preferably a pixel's distance, a half pixel's distance, a quarter pixel's distance or any partial pixel's distance. That is the control device changes a pattern of the exposure images every time the exposure device moves a pixel's distance, a half pixel's distance, a quarter pixel's distance, or any partial pixel's distance. The exposure image can also change continuously like an animation movie while the exposure device moves continuously.

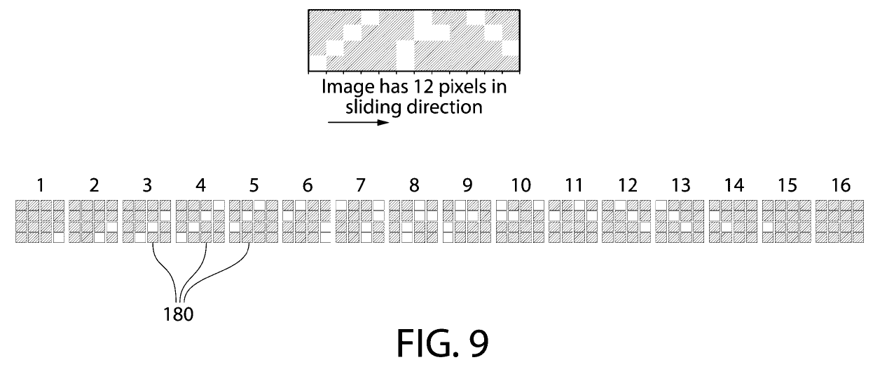

FIG. 9 illustrates an exemplary slicing process of the slicer algorithm in accordance with the present invention showing the image patterns 180. In the 2D plane, the transition of the exposure patterns happens every time the exposure device 112 moves a distance of a single pixel via the linear actuator 160 and the control device. Depending on the settings, the pixel size may range from 1 μm to 1000 μm. In vertical motion, the transition of the exposure patterns happens every time the platform 114 lifts a certain distance (e.g. ranges from 0.1 μm to 1000 μm) or continuously.

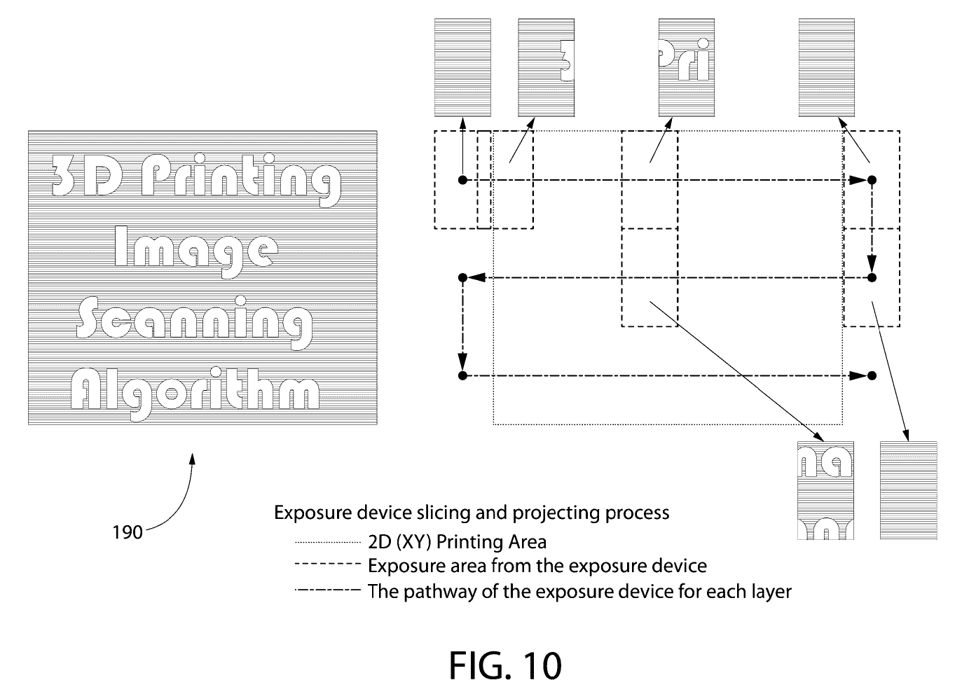

The slicer algorithm first slices the representative 3D model into a plurality of layer-by-layer 2D images. Then each of those 2D images is further divided into the final exposure images that fit the exposure resolution of the exposure device. FIG. 10 shows a printing process in accordance with the slicer algorithm of the second exemplary embodiment of the present invention, showing the sliding pathway of the exposure device and the change of exposure images for a 2D layer for a target exposure image 190 for the layer. For example, if the overall 2D exposure image of each layer has a resolution of 3240×1920 pixels while the exposure device 112 only has the exposure resolution of 1920×1080, this 2D image will be divided into 4319 images with resolution of 1920×1080. If the overall 2D image has a resolution of 3240×3240 while the exposure device 112 only has the exposure resolution of 1920×1080, the 2D image will be divided into 8638 images with resolution of 1920×1080. The formula for the slicer algorithm is:
When I₂≦P₁, the number of further divided images=I₁+P₂−1;
When I₂≧P₁, the number of further divided images=(I₂+P₂−1)×n;
Where the overall 2D image resolution: I₁×I₂ (I₁≧I₂);
Projecting device resolution: P₁×P₂ (P₁≧P₂);
Where I is the number of pixels of the overall projected image (i.e. the resolution of the overall XY build volume), P is the number of pixels of the resolution of the exposure device 112, and n is a rounding integer of the quotient from I₂/P₂, and n≧the quotient.

The projecting images in two different nearby pathways may have an overlapped region, which can be used to bond the printed objects as an integration. The width of the overlapped region may range, for example, from 0.25-2 pixels. Grayscale may be applied in the exposure pixels of the overlapped regions.

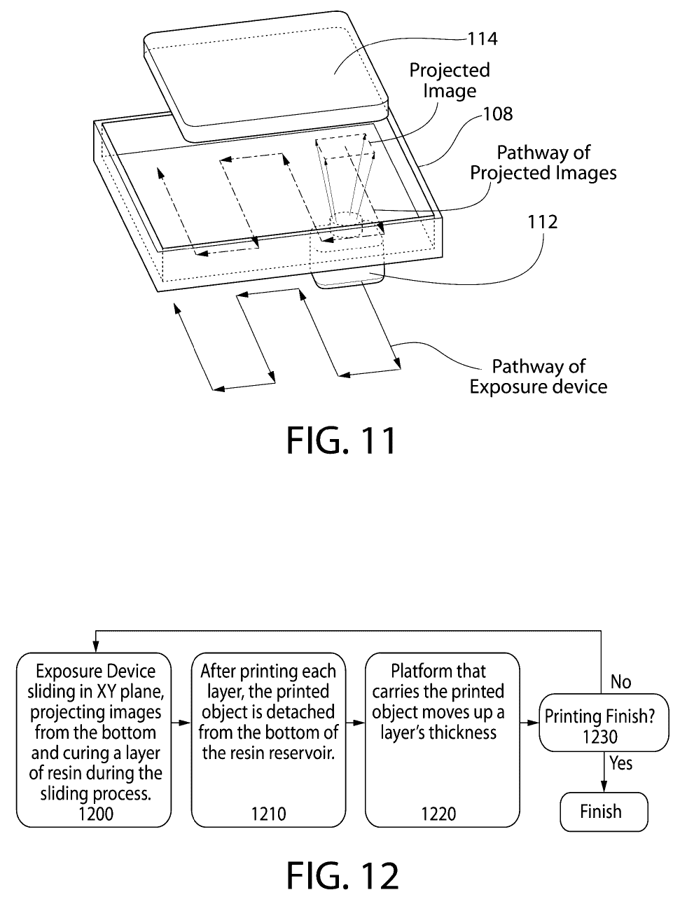

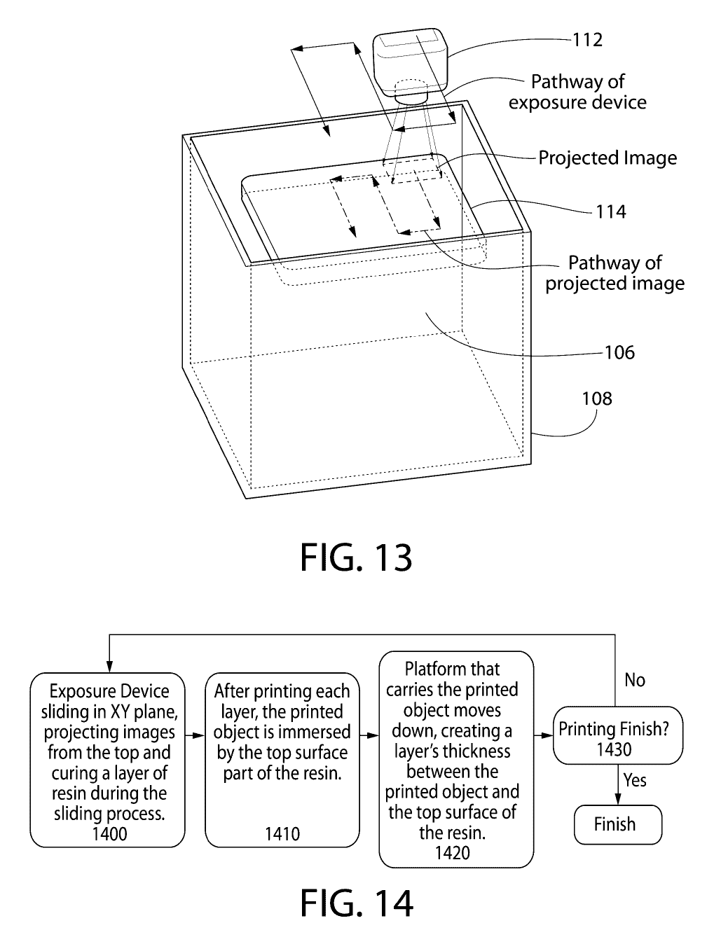

The all dimensional fabrication based on the slicing algorithm of the second embodiment may be achieved by two different system, including a bottom-up system (FIGS. 11 and 12) and a top-down system (FIGS. 13 and 14). For the bottom-up system, the exposure device 112 projects images from the bottom or below the building platform 114, through an optically transparent portion of the resin reservoir 108, and cures the bottom portion of the resin 106 in the reservoir 108. Thus, the exposure device 112 and the linear actuator 160 on which the exposure device 112 is supported are both facing up toward the reservoir. As seen in FM. 12, the fabrication apparatus will first print a 2D layer by continuously sliding the exposure device 112 in XY direction via the linear actuator through the pathway (shown as arrows in FIG. 11) at step 1200. After the whole layer is printed, a detachment process may be applied to separate the printed object and the bottom of the reservoir at step 1210. Next, the build platform together with the printed object will move away from the reservoir in the Z direction and leave a layer's thickness between the printed object and the bottom of the reservoir at step 1220, which allows another layer to be printed at step 1230.

The present invention contemplates several ways of detaching the printed object from the bottom of the reservoir including lifting the platform 114 up and down, tilting the reservoir 108 with an angle away from the printed object, or sliding the reservoir with respect to the printed object. Alternatively, the bottom of the reservoir may be formed as a flexible film, similar to the film of the first embodiment, and by applying pressure thereto, as described above with respect to the first embodiment, deforms the bottom of the reservoir to separate the printed object therefrom.

For the top-down printing system (FIGS. 13 and 14), the exposure device 112 projects images from the top, thereby curing the top portion of the resin in the reservoir. Thus, the exposure device 112 and the linear actuator 160 which supports the exposure device 112 both face down toward the reservoir. As seen in FIG. 14, the fabrication apparatus first prints a 2D layer by continuously sliding the exposure device 112 in the XY direction through the pathway (shown as arrows in FIG. 13) at step 1400. After the whole layer is printed, an immersion process may be applied such that the resin covers the printed object at step 1410. The build platform 114 together with the printed object, which are submerged in the resin, move in the Z direction toward the bottom of the reservoir and leave a layer's thickness of resin covering the printed object at step 1420, which allows another layer to be printed at step 1430. The printed object may be immersed in the resin by any known manner, such as by moving the platform down and up or applying a wiper or sprayer that covers the top part of the printed object with resin.

Multiple exposure devices may be applied together to further enlarge the build area and increase the printing speed. The sliding of the exposure devices may also be simplified into one dimensional motion, thus only one arm and one linear actuator are needed to control either the X or Y motion.

While particular embodiments have been chosen to illustrate the invention, it will be understood by those skilled in the art that various changes and modifications can be made therein without departing from the scope of the invention as defined in the appended claims.

1-36. (canceled)

37. A continuous fabrication apparatus for printing an all dimensional object, comprising:
a platform;
a gas-permeable flexible film having a carrier surface, wherein a printing area is defined between said platform and said gas-permeable flexible film for printing the object, said gas-permeable film being optically transparent;
a reservoir holding a photocurable resin in said printing area;
a pressure controlled air chamber adjacent said reservoir and sealed by said gas-permeable flexible film such that said gas-permeable flexible film divides said reservoir and said pressure controlled air chamber, at least a portion of said pressure controlled air chamber being optically transparent; and
a light exposing device configured to cure said printing area through said gas-permeable flexible film to form the object from said photocurable resin.

38. The continuous fabrication apparatus of claim 37, wherein said printing area includes an isolating layer on said carrier surface of said gas-permeable flexible film, wherein said isolating layer inhibits polymerization of said resin, thereby allowing the object to separate from said gas-permeable flexible film.

39. The continuous fabrication apparatus of claim 37, further comprising
an oxygen concentration control system coupled to said pressure controlled air chamber that determines said predetermined concentration of oxygen and supplies said predetermined concentration of oxygen to said pressure controlled air chamber.

40. The continuous fabrication apparatus of claim 38, further comprising
a control device operatively associated with said platform for lifting said platform away from said gas-permeable flexible film while printing the object in said printing area such that said printing area continuously includes a fully cured region adjacent said platform and a partially cured region adjacent said isolating layer.

41. The continuous fabrication apparatus of claim 37, further comprising
a pressure control system coupled to said pressure controlled air chamber, the pressure control system increases or decreases the pressure in said pressure controller air chamber to maintain said gas-permeable film in a substantially flat state.

47. The continuous fabrication apparatus of claim 37, further comprising
a sliding mechanism coupled to said reservoir for sliding said reservoir in either the horizontal direction or rotationally about the vertical direction with respect to said platform.

43. The continuous fabrication apparatus of claim 38, wherein
a tension mechanism is incorporated into said reservoir for applying tension to said gas-permeable film.

44. A method for continuous fabrication of an all dimensional object, comprising the steps of:
providing a printing area defined between a platform and a gas-permeable flexible film, the gas-permeable film being optically transparent;
providing a reservoir holding a photocurable resin in the printing area;
providing a pressure controlled air chamber adjacent said reservoir and sealed by the gas-permeable flexible film such that the gas-permeable flexible film divides the reservoir and the pressure controlled air chamber, at least a portion of the air chamber being optically transparent; and
curing the photocurable resin in the printing area through the gas-permeable flexible film to form the object while lifting the object away from the gas-permeable film.

45. The method according to claim 44, further comprising the step of
supplying a predetermined concentration of oxygen to the pressure controlled air chamber and through the gas-permeable film to inhibit polymerization of the resin, thereby creating an isolating layer on the gas-permeable film.

46. The method according to claim 45, further comprising the step of
tuning the concentration of oxygen in the pressure controlled air chamber to maintain a desired thickness of the isolating layer.

47. The method according to claim 46, wherein
the step of tuning includes increasing the oxygen concentration in the pressure controlled air chamber to feed a higher concentration of oxygen through the gas-permeable film, thereby increasing the thickness of the isolating layer.

48. The method according to claim 44, further comprising the step of
tuning the pressure in the pressure controlled air chamber to maintain the gas-permeable film in a substantially flat state, or tightening the gas-permeable film to maintain the gas-permeable film in a substantially flat state.

49. The method according to claim 44, wherein
the step of curing includes providing a light exposure device that either continuously or sequentially projects images or patterns toward the photocurable resin.

50. A method for fabrication of an all dimensional object, comprising the steps of:
providing a platform for building the all dimensional object, the platform is movable in a Z direction;
providing a reservoir holding a photocurable resin in the printing area;
providing at least one exposure device for curing the photocurable resin in the printing area;
providing a linear actuator coupled to the exposure device for linearly sliding the exposure device in an XX plane while curing the photocurable resin;
providing a control device operatively coupled to the exposure device and the linear actuator to provide exposure images for printing the object; and
printing the all dimensional object by sliding the exposure device using the linear actuator and projecting the exposure images into the photocurable resin.

51. The method according to claim 50, wherein
the control device being programmed to have an algorithm to slice a 3D model of the object into a plurality of 2D images, and slice each of the plurality of 2D images into the exposure images for projecting from the at least one exposure device that fit a desired resolution of the exposure device.

52. The method according to claim 51, wherein
the control device changes a pattern of the exposure images every time the at least one exposure device moves a pixel's distance or any partial pixel's distance, or at least one exposure device moves continuously in animation mode.

53. The method according to claim 52, wherein
the control device transitions the exposure patterns every time the at least one exposure device moves a distance of a single pixel via the linear actuator.

54. The method according to claim 51 wherein
the slicer algorithm is,
When I₂≦P₁, the number of further divided images=I₁+P₂−1;
When I₂≧P₁, the number of further divided images=(I₁+P₂−1)×n;
Where the overall 2D image resolution: I₁×I₂(I₁≧I₂);
Projecting device resolution: P₁×P₂(P₁≧P₂);
Where I is the number of pixels of the overall projected image, P is the number of pixels of the resolution of the exposure device, and n is a rounding integer of the quotient from I₂/P₂, and n≧the quotient.

55. The method according to claim 50, wherein
the at least exposure device projects the exposure images from below the building platform and the reservoir, wherein at least a portion of a bottom of the reservoir is optically transparent.

56. The method according to claim 50, wherein
the linear actuator includes first and second arms that are perpendicular with respect to one another, the at least one exposure device being slidable with respect to each of the first and second arms.
